(19) United States
(12) Patent Application Publication
(10) Pub. No.: US 2020/0182974 A1
(43) Pub. Date: Jun. 11, 2020

(54) VERTICAL CAVITY SURFACE EMITTING LASER-BASED PROJECTOR

(71) Applicant: Magik Eye Inc., New York, NY (US)

(72) Inventor: Akiteru Kimura, Hachioji (JP)

(21) Appl. No.: 16/701,949

(22) Filed: Dec. 3, 2019

Related U.S. Application Data
(60) Provisional application No. 62/777,083, filed on Dec. 8, 2018.
(60) Provisional application No. 62/780,230, filed on Dec. 15, 2018.

(51) Int. Cl. G01S 7/481; G02B 27/00; G01S 17/08

(52) U.S. Cl. CPC G01S 7/4814; G01S 17/08; G02B 27/0037

(57) ABSTRACT

In one example, a distance sensor includes a projection system. A light receiving system, and a processor. The projection system includes a plurality of laser light sources arranged in an array to emit a plurality of beams of light that forms a grid-shaped projection pattern when the plurality of beams of light is incident on a surface and a compensation optic to minimize a magnification-induced curvilinear distortion of the grid-shaped projection pattern before the plurality of beams of light is incident on the surface. The light receiving system captures an image of the grid-shaped projection pattern on the surface. The processor calculates a distance from the distance sensor to the surface, based on an appearance of the grid-shaped projection pattern in the image.

### CROSS REFERENCE TO RELATED APPLICATIONS

This application claims the priority of United States Provisional Patent Applications Ser. Nos. 62/777,083, filed Dec. 8, 2018, and 62/780,230, filed Dec. 15, 2018, which are herein incorporated by reference in their entireties.

### BACKGROUND

U.S. patent application Ser. Nos. 14/920,246, 15/149,323, and 15/149,429 describe various configurations of distance sensors. Such distance sensors may be useful in a variety of applications, including security, gaming, control of unmanned vehicles, operation of robotic or autonomous appliances, and other applications.

The distance sensors described in these applications include projection systems (e.g., comprising lasers, diffractive optical elements, and/or other cooperating components) which project beams of light in a wavelength that is substantially invisible to the human eye (e.g., infrared) into a field of view. The beams of light spread out to create a pattern (of dots, dashes, or other artifacts) that can be detected by an appropriate light receiving system (e.g., lens, image capturing device, and/or other components). When the pattern is incident upon an object in the field of view, the distance from the sensor to the object can be calculated based on the appearance of the pattern (e.g., the positional relationships of the dots, dashes, or other artifacts) in one or more images of the field of view, which may be captured by the sensor's light receiving system. The shape and dimensions of the object can also be determined.

For instance, the appearance of the pattern may change with the distance to the object. As an example, if the pattern comprises a pattern of dots, the dots may appear closer to each other when the object is closer to the sensor, and may appear further away from each other when the object is further away from the sensor.

### SUMMARY

In one example, a distance sensor includes a projection system. A light receiving system, and a processor. The projection system includes a plurality of laser light sources arranged in an array to emit a plurality of beams of light that forms a grid-shaped projection pattern when the plurality of beams of light is incident on a surface and a compensation optic to minimize a magnification-induced curvilinear distortion of the grid-shaped projection pattern before the plurality of beams of light is incident on the surface. The light receiving system captures an image of the grid-shaped projection pattern on the surface. The processor calculates a distance from the distance sensor to the surface, based on an appearance of the grid-shaped projection pattern in the image.

In another example, a method performed by a processing system of a distance sensor includes sending a first signal to a projection system of the distance sensor that includes an array of laser light sources and a compensation optic, wherein the first signal causes the array of laser light sources to emit a plurality of beams of light that creates a grid-shaped projection pattern when the plurality of beams of light is incident on a surface, and wherein the compensation optic minimizes a magnification-induced curvilinear distortion of the grid-shaped projection pattern before the plurality of beams of light is incident on the surface, sending a second signal to a light receiving system of the distance sensor, wherein the second signal causes the light receiving system to capture an image of the grid-shaped projection pattern projected onto the surface, and calculating a distance from the distance sensor to the surface, based on appearances of the grid-shaped projection pattern in the image.

In another example, a non-transitory machine-readable storage medium is encoded with instructions executable by a processor. When executed, the instructions cause the processor to perform operations including sending a first signal to a projection system of the distance sensor that includes an array of laser light sources and a compensation optic, wherein the first signal causes the array of laser light sources to emit a plurality of beams of light that creates a grid-shaped projection pattern when the plurality of beams of light is incident on a surface, and wherein the compensation optic minimizes a magnification-induced curvilinear distortion of the grid-shaped projection pattern before the plurality of beams of light is incident on the surface, sending a second signal to a light receiving system of the distance sensor, wherein the second signal causes the light receiving system to capture an image of the grid-shaped projection pattern projected onto the surface, and calculating a distance from the distance sensor to the surface, based on appearances of the grid-shaped projection pattern in the image.

### BRIEF DESCRIPTION OF THE DRAWINGS

FIG. 1 illustrates a side view of one example of a projection system that may be used in a distance sensor such as any of the sensors described above;

FIG. 2A illustrates an example of a target projection pattern;

FIG. 2B illustrates an example of a distorted projection pattern which may be formed by the projection system of FIG. 1;

FIG. 3 illustrates a side view of one example of a projection system according to examples of the present disclosure;

FIG. 4 illustrates a side view of another example of a projection system according to examples of the present disclosure;

FIG. 5 illustrates a side view of another example of a projection system according to examples of the present disclosure;

FIG. 6 illustrates a side view of another example of a projection system according to examples of the present disclosure;

FIG. 7 illustrates a block diagram of an example distance sensor of the present disclosure;

FIG. 8 is a flow diagram illustrating one example of a method for distance measurement using a distance sensor with a compensation optic for minimizing distortions in the projection pattern, e.g., as illustrated in FIG. 7; and

FIG. 9 depicts a high-level block diagram of an example electronic device for calculating the distance from a sensor to an object.

### DETAILED DESCRIPTION

[owls] The present disclosure broadly describes a vertical cavity surface emitting laser-based projector for use in three-dimensional distance sensors. As discussed above, distance sensors such as those described in U.S. patent application Ser. Nos. 14/920,246, 15/149,323, and 15/149,429 determine the distance to an object (and, potentially, the shape and dimensions of the object) by projecting beams of light that spread out to create a pattern (e.g., of dots, dashes, or other artifacts) in a field of view that includes the object. The beams of light may be projected from one or more laser light sources which emit light of a wavelength that is substantially invisible to the human eye, but which is visible to an appropriate detector (e.g., of the light receiving system). The three-dimensional distance to the object may then be calculated based on the appearance of the pattern to the detector.

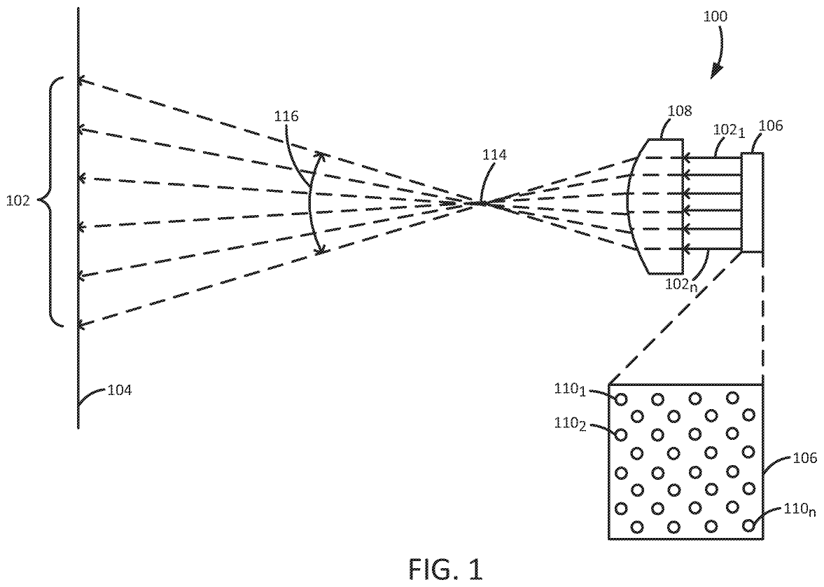

FIG. 1 illustrates a side view of one example of a projection system 100 that may be used in a distance sensor such as any of the sensors described above. As illustrated the projection system 100 may project a plurality of beams 102 of light. When each beam 102 is incident upon a surface 104, each beam may create an artifact such as a dot, a dash, or the like on the surface 104. Collectively, the artifacts created by all of the beams 102 form the above-described pattern from which the distance to the object can be calculated.

As shown in FIG. 1, the projection system 100 may generally comprise a laser array 106 and a lens 108. A more detailed illustration of an example laser array 106 is shown in the inset of FIG. 1, which shows a top view of the laser array 106. As illustrated, in one example, the laser array 106 comprises a vertical cavity surface emitting laser (VCSEL) array. The VCSEL array may comprise a plurality of apertures 110₁-110ₙ (hereinafter individually referred to as an “aperture 110” or collectively referred to as “apertures 110” arranged in predetermined intervals in a two-dimensional grid pattern. A laser emitter (not shown) may be positioned behind each of the apertures 110. The example illustrated in FIG. 1 has been simplified; the laser array 106 may comprise additional components, such as metal contacts, Bragg reflectors, and the like, which are not shown.

Each laser emitter of the VCSEL array emits a beam 102₁-102ₙ of coherent light (hereinafter individually referred to as a “beam 102 of light” or collectively referred to as “beams 102 of light”) which passes through a corresponding aperture 110 of the laser array 106. Each beam 102 of light has a predetermined divergence angle and projection angle. In one example, the beams 102 of light are parallel to each other as the beams 102 of light propagate from the laser array 106. The beams 102 of light are subsequently collected by the lens 108.

One advantage of using a VCSEL array for the light source of the projection system 100 (as opposed to using a different type of laser source, such as an edge emitting laser) is size. In particular, VCSELs tend to be much smaller (as well as less costly and more temperature-stable) than other types of lasers. This allows the projection system 100 (and, therefore, the distance sensor of which the projection system 100 is part) to be manufactured with a relatively small form factor. However, because VCSELs are so small, the projection pattern created by the beams of light 102 may need to be magnified in order for the projection pattern created on the surface 104 to be large enough for effective distance measurement.

As such, the lens 108 may comprise a converging lens (e.g., a bioconvex or a plano-convex lens), which has positive optical power. In this case, the collimated beams 102 of light passing through the lens 108 may converge to a focal point 114 behind the lens 108 before spreading out or diverging from the focal point 114 to magnify the projection pattern. As the beams 102 of light spread from the focal point 114, the spread may have a projection angle 116 as the beams 102 of light are directed toward the surface 104.

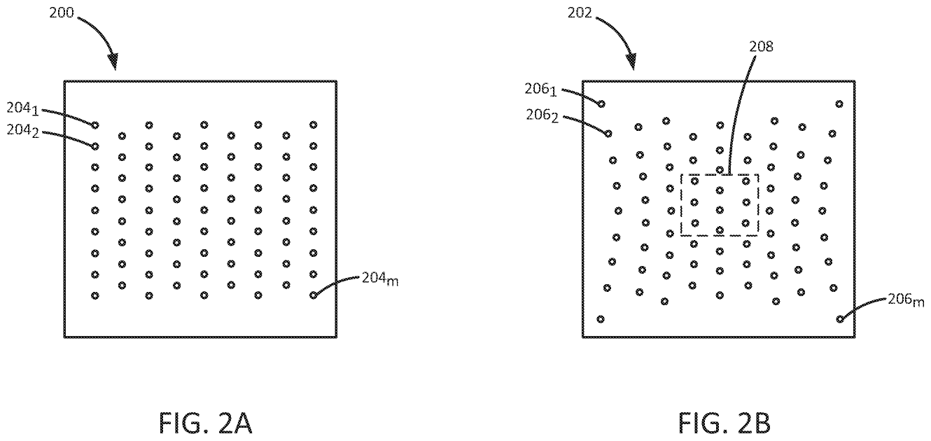

Although the lens 108 effectively magnifies the projection pattern, it may also distort the projection pattern. For instance, FIG. 2A illustrates an example of a target projection pattern 200, while FIG. 2B illustrates an example of a distorted projection pattern 202 which may be formed by the projection system 100 of FIG. 1. The target projection pattern 200 may represent a desired arrangement of projection artifacts on a surface or object, while the distorted projection pattern 202 may represent an arrangement of projection artifacts that has been distorted due to the optics of the projection system 100 (and, more specifically, distorted by the lens 108).

In one example, the target projection pattern 200 is arranged in a manner that is consistent with the projection patterns disclosed in U.S. patent application Ser. Nos. 16/150,918 and 16/164,113. As illustrated, the projection artifacts 204₁-204ₘ (hereinafter individually referred to as a “projection artifact 204” or collectively referred to as “projection artifacts 204”) are arranged in a grid pattern, where the grid pattern has a substantially rectangular shape in which all of the rows are parallel to each other, and all of the columns are parallel to each other. The positional relationships of the projection artifacts 204 in the grid pattern may be substantially regular. In turn, the trajectories of the projection artifacts 204 (i.e., the movements of the projection artifacts 204 with distance from an object) will be parallel to each other, which allows for easy correlation of projection points 204 to beams of light and efficient calculation of distance.

In the distorted projection pattern 204, by contrast, the projection artifacts 206₁-206ₘ (hereinafter individually referred to as a “projection artifact 206” or collectively referred to as “projection artifacts 206”) are arranged in a grid pattern, where the grid pattern has a substantially pin cushion shape caused by curvilinear distortions. In this case, the rows and the columns of the grid pattern bow inward, e.g., toward a center of the distorted projection pattern 202. As shown in FIG. 2A, some rows and columns may bow more than others. As a result, the trajectories of many of the projection artifacts 206 will not be parallel to each other and may, in fact, overlap each other in some cases. As such, more complex calculations (and therefore more time) may be needed in order to calculate distance.

It should be noted, however, that a portion of the distorted projection pattern 204 (i.e., specifically the middle portion 208) may remain relatively undistorted. That is, the trajectories of the projection artifacts 206 appearing in the middle portion 208 of the distorted projection pattern 204 may be relatively parallel to each other. Thus, the middle portion 208 of the distorted projection pattern 204 may still be usable for distance calculations; however, the usefulness is limited to the middle portion 208 and, therefore, the use of the distorted projection pattern 204 may not necessarily be the most efficient projection pattern for distance calculations.

Examples of the present disclosure provide a VCSEL-based projector that is capable of magnifying a projection pattern created by a VCSEL array while minimizing distortion of the projection pattern. In some examples, the projector includes a VCSEL array, a first lens to magnify a projection pattern created by the beam, of light emitted by the VCSEL array, and a second lens, positioned behind the focal point of the first lens, to compensate for distortions in the projection pattern that may be introduced by the first lens. In some examples, a diffractive optical element may be used in place of the second lens. In other examples, the projector may include a VCSEL array and a single aspheric lens that both magnifies and compensates for distortions in the projection pattern. Thus, examples of the present disclosure make use of compensation optics (e.g., additional lens, diffractive optical elements, and/or aspheric lenses) in order to ensure that the projection pattern projected onto an object is both large enough and properly arranged (e.g., the trajectories of the individual projection artifacts are substantially parallel to each other) to allow for efficient distance calculations. The compensation optics may be positioned between the light source (e.g., the VCSEL array) and the object.

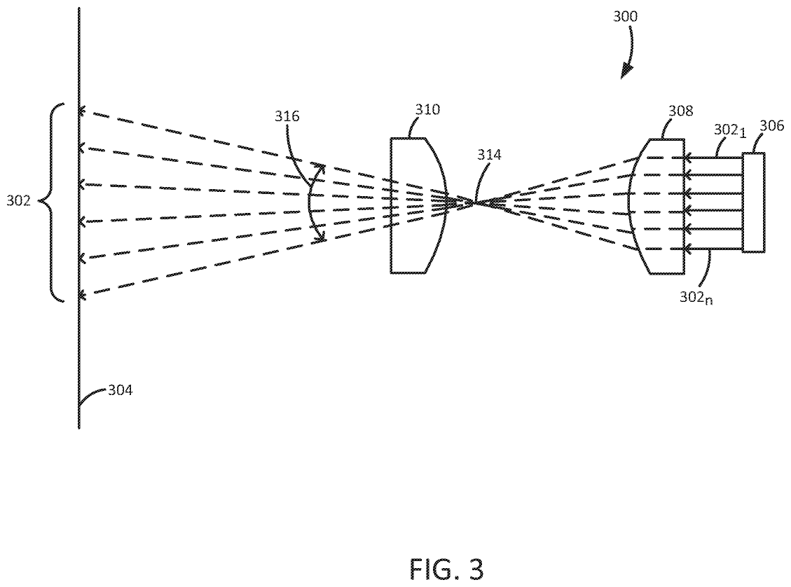

FIG. 3 illustrates a side view of one example of a projection system 300 according to examples of the present disclosure. Like the projection system 100, the projection system 300 may be used in a distance sensor such as any of the sensors described above. As illustrated, the projection system 300 may project a plurality of beams 302 of light. When each beam 302 is incident upon a surface 304, each beam may create an artifact such as a dot, a dash, or the like on the surface 304. Collectively, the artifacts created by all of the beams 302 form the above-described pattern from which the distance to the object can be calculated.

As shown in FIG. 3, the projection system 300 may generally comprise a laser array 306, a first lens 308, and a second lens 310. In one example, the laser array 306 has dimensions of approximately two millimeters by two millimeters. The laser array 306 may be arranged in a manner similar to the example laser array 106 of FIG. 1. For instance, the laser array 306 may comprise a VCSEL array in which each laser emitter of the VCSEL array emits a beam 302₁-302ₙ of light (hereinafter individually referred to as a “beam 302 of light” or collectively referred to as “beams 302 of light”) which passes through a corresponding aperture (not shown) of the laser array 306. In one example, the beams 302 of light are parallel to each other as the beams 302 of light propagate from the laser array 306. The beams 302 of light are subsequently collected by the first lens 308.

The first lens 308 may comprise a converging lens (e.g., a bioconvex or a plano-convex lens), which has positive optical power. In this case, the collimated beams 302 of light passing through the lens 308 may converge to a focal point 314 behind the lens 308 before spreading out from the focal point 314 to magnify the projection pattern. In one example, the focal length (e.g., the distance from the surface of the laser array 306 to the focal point 314) is approximately five millimeters.

The second lens 310 may also comprise a converging lens (e.g., a bioconvex or a plano-convex lens), which has positive optical power. The second lens 310 may be positioned behind the focal point 314 of the first lens 308, e.g., between the first lens 308 and the surface 304. Thus, the beams 302 of light may pass through the second lens 310 after the beams 302 of light begin to spread or diverge. As such, the projection angle 316 of the spread (which may be predetermined) as the beams 302 of light are directed toward the surface 304 may be a composite of a projection angle of the first lens 308 and a projection angle of the second lens 310. This composite projection angle 316 may compensate for distortions in the projection pattern which may be introduced by the first lens 308, and the resulting projection pattern that is formed on the surface 304 may have an appearance that is substantially similar to the target projection pattern illustrated in FIG. 2A (e.g., in which the trajectories of the projection artifacts are substantially parallel to each other).

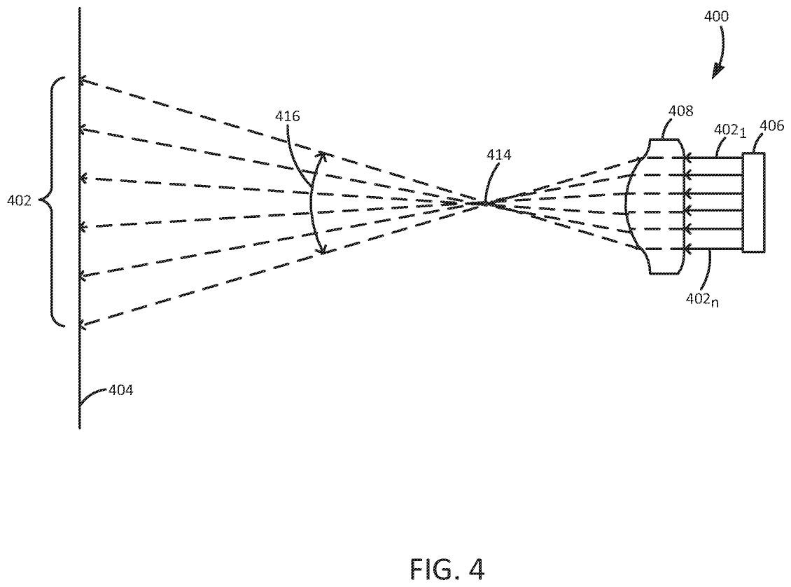

FIG. 4 illustrates a side view of another example of a projection system 400 according to examples of the present disclosure. Like the projection systems 100 and 300, the projection system 400 may be used in a distance sensor such as any of the sensors described above. As illustrated, the projection system 400 may project a plurality of beams 402 of light. When each beam 402 is incident upon a surface 404, each beam may create an artifact such as a dot, a dash, or the like on the surface 404. Collectively, the artifacts created by all of the beams 402 form the above-described pattern from which the distance to the object can be calculated.

As shown in FIG. 4, the projection system 400 may generally comprise a laser array 406 and a lens 408. In one example, the laser array 406 has dimensions of approximately two millimeters by two millimeters. The laser array 406 may be arranged in a manner similar to the example laser array 106 of FIG. 1. For instance, the laser array 406 may comprise a VCSEL array in which each laser emitter of the VCSEL array emits a beam 402₁-402ₙ of light (hereinafter individually referred to as a “beam 402 of light” or collectively referred to as “beams 402 of light”) which passes through a corresponding aperture (not shown) of the laser array 406. In one example, the beams 402 of light are parallel to each other as the beams 402 of light propagate from the laser array 406. The beams 402 of light are subsequently collected by the lens 408.

The lens 408 may comprise an aspheric lens whose surface profile (e.g., which is not a portion of a sphere or a cylinder) may minimize optical aberrations. In this case, the collimated beams 402 of light passing through the lens 408 may converge to a focal point 414 behind the lens 408 before spreading out or diverging from the focal point 414 to magnify the projection pattern. In one example, the focal length (e.g., the distance from the surface of the laser array 406 to the focal point 414) is approximately five millimeters. As the beams 402 of light spread from the focal point 414, the spread may have a projection angle 416 (which may be predetermined) as the beams 402 of light are directed toward the surface 404. The resulting projection pattern that is formed on the surface 404 may have an appearance that is substantially similar to the target projection pattern illustrated in FIG. 2A (e.g., in which the trajectories of the projection artifacts are substantially parallel to each other).

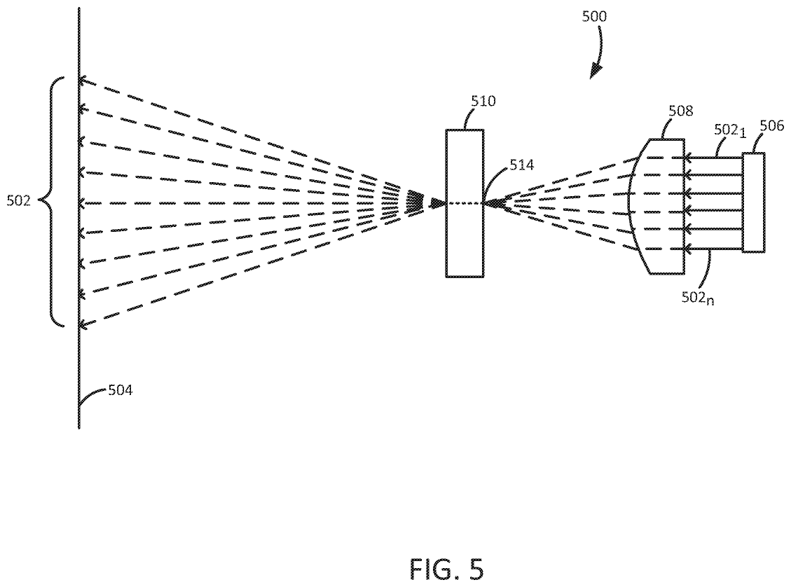

FIG. 5 illustrates a side view of another example of a projection system 500 according to examples of the present disclosure. Like the projection systems 100, 300, and 400, the projection system 500 may be used in a distance sensor such as any of the sensors described above. As illustrated, the projection system 500 may project a plurality of beams 502 of light. When each beam 502 is incident upon a surface 504, each beam may create an artifact such as a dot, a dash, or the like on the surface 504. Collectively, the artifacts created by all of the beams 502 form the above-described pattern from which the distance to the object can be calculated.

As shown in FIG. 5, the projection system 500 may generally comprise a laser array 506, a lens 508, and a diffractive optical element 510. In one example, the laser array 506 has dimensions of approximately two millimeters by two millimeters. The laser array 506 may be arranged in a manner similar to the example laser array 106 of FIG. 1. For instance, the laser array 506 may comprise a VCSEL array in which each laser emitter of the VCSEL array emits a beam 502₁-502ₙ of light (hereinafter individually referred to as a “beam 502 of light” or collectively referred to as “beams 502 of light”) which passes through a corresponding aperture (not shown) of the laser array 506. In one example, the beams 502 of light are parallel to each other as the beams 502 of light propagate from the laser array 506. The beams 502 of light are subsequently collected by the lens 508.

The lens 508 may comprise a converging lens (e.g., a bioconvex or a plano-convex lens), which has positive optical power. In this case, the collimated beams 502 of light passing through the lens 508 may converge to a focal point 514 behind the lens 508. In one example, the focal length (e.g., the distance from the surface of the laser array 506 to the focal point 514) is approximately five millimeters.

The diffractive optical element 510 may comprise a conical mirror, a holographic film, or other phase element that uses interference and diffraction to create a distribution of beams of light from a collimated (e.g., single) beam. The diffractive optical element 510 may be positioned at the focal point 514 of the lens 508, e.g., between the lens 508 and the surface 504. Thus, the beams 502 of light may pass through the diffractive optical element 510 just as the beams 502 converge or are collimated at the focal point 514 of the lens 508. The diffractive optical element 510 may then split the collimated light back into a plurality of beams 502 of light that are distributed to produce the projection pattern on the surface 504.

In one example, the beams 502 of light that are distributed by the diffractive optical element 510 may be incident on the surface 504 to duplicate the distorted, pincushion-shaped projection pattern created by the lens 508 (and like the projection pattern illustrated in FIG. 2B). However, the addition of the diffractive optical element 510 magnifies the pin cushion-shaped projection pattern. Thus, the middle portion of the distorted, pin cushion-shaped projection pattern (which may be usable due to maintaining the substantially parallel orientation of the projection artifact trajectories, as discussed above) is also magnified. The magnification of the middle portion of the projection pattern may compensate for edges of the projection pattern, which remain distorted or bowed.

In an alternative example of the projection system 500, the lens 508 is an aspheric lens rather than a converging lens. The arrangement of the lens 508 with respect to the laser array 506 and the diffractive optical element 510 may be the same. In this case, the projection pattern that is projected onto the surface 504 may not be distorted (e.g., may resemble the target projection pattern 200 of FIG. 2A).

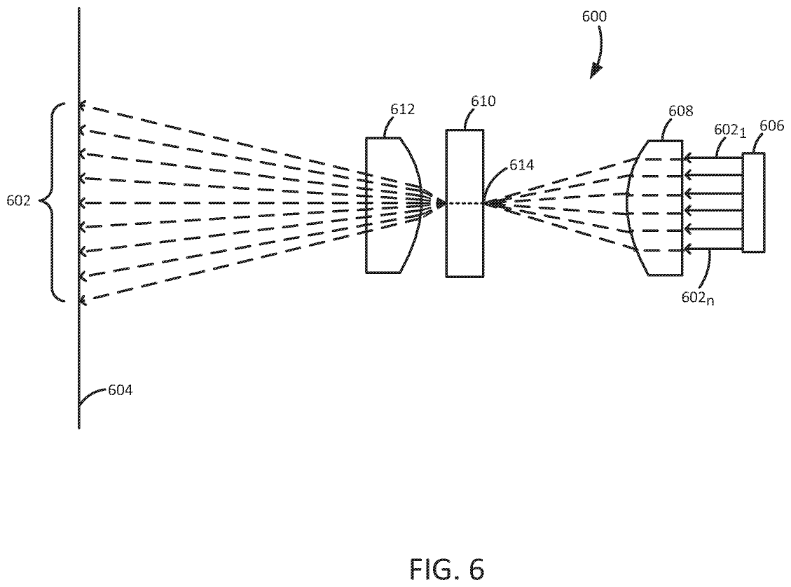

FIG. 6 illustrates a side view of another example of a projection system 600 according to examples of the present disclosure. Like the projection systems 100, 300, 400, and 500 the projection system 600 may be used in a distance sensor such as any of the sensors described above. As illustrated, the projection system 600 may project a plurality of beams 602 of light. When each beam 602 is incident upon a surface 604, each beam may create an artifact such as a dot, a dash, or the like on the surface 604. Collectively, the artifacts created by all of the beams 602 form the above-described pattern from which the distance to the object can be calculated.

As shown in FIG. 6, the projection system 600 may generally comprise a laser array 606, a first lens 608, a diffractive optical element 610, and a second lens 612. In one example, the laser array 606 has dimensions of approximately two millimeters by two millimeters. The laser array 606 may be arranged in a manner similar to the example laser array 106 of FIG. 1. For instance, the laser array 606 may comprise a VCSEL array in which each laser emitter of the VCSEL array emits a beam 602₁-602ₙ of light (hereinafter individually referred to as a “beam 602 of light” or collectively referred to as “beams 602 of light”) which passes through a corresponding aperture (not shown) of the laser array 606. In one example, the beams 602 of light are parallel to each other as the beams 602 of light propagate from the laser array 606. The beams 602 of light are subsequently collected by the first lens 608.

The first lens 608 may comprise a converging lens (e.g., a bioconvex or a plano-convex lens), which has positive optical power. In this case, the collimated beams 602 of light passing through the lens 608 may converge to a focal point 614 behind the lens 608. In one example, the focal length (e.g., the distance from the surface of the laser array 606 to the focal point 614) is approximately five millimeters.

The diffractive optical element 610 may comprise a conical mirror, a holographic film, or other phase element that uses interference and diffraction to create a distribution of beams of light from a collimated (e.g., single) beam. The diffractive optical element 610 may be positioned at the focal point 614 of the lens 608. Thus, the beams 602 of light may pass through the diffractive optical element 610 just as the beams 602 converge or are collimated at the focal point 614 of the lens 608. The diffractive optical element 610 may then split the collimated light back into a plurality of beams 602 of light that are directed toward the second lens 612. Thus, the diffractive optical element 610 is positioned between the first lens 608 and the second lens 612 (e.g., along the direction of propagation of the beams 602 of light).

The second lens 612, like the first lens 608, may comprise a converging lens (e.g., a bioconvex or a plano-convex lens), which has positive optical power. The second lens 612 distributes the beams 602 of light to produce the projection pattern on the surface 604. The resulting projection pattern that is formed on the surface 604 may have an appearance that is substantially similar to the target projection pattern illustrated in FIG. 2A (e.g., in which the trajectories of the projection artifacts are substantially parallel to each other).

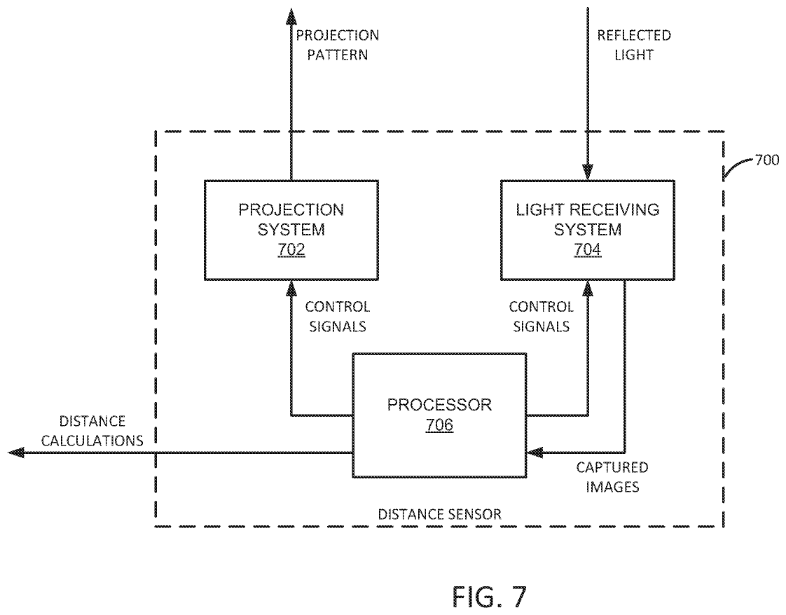

FIG. 7 illustrates a block diagram of an example distance sensor 700 of the present disclosure. The distance sensor 700 may generally include a projection system 702, a light receiving system 704, and a processor 706. The projection system 702, the light receiving system, and the processor 706 may be contained within a common housing (not shown) which may also contain other components that are not illustrated, such as a power supply, a communication interface, and the like.

The projection system 702 is configured to project a projection pattern into a field of view, where the projection pattern is formed when a plurality of beams of light are incident on a surface in the field of view to form a plurality of projection artifacts on the surface. The arrangement of the projection artifacts forms a pattern from which the distance from the distance sensor 700 to the surface may be calculated. In one example, the projection system 702 may include a VCSEL array to emit the plurality of beams of light and a compensation optic that minimizes distortion of the projection pattern created by the plurality of beams of light. Thus, the projection system 702 may be configured according to any of the examples illustrated in FIGS. 3-6.

The light receiving system 702 may comprise any type of camera that is capable of capturing an image in the field of view that includes the projection pattern. For instance, the camera may comprise a red, green, blue (RGB) camera. In one example, the camera may also include a lens (e.g., a wide angle lens such as a fisheye lens or a mirror optical system) and a detector that is capable of detecting light of a wavelength that is substantially invisible to the human eye (e.g., an infrared detector). In one example, the lens of the camera may be placed in the center of the projection system (e.g., in the center of the VCSEL array.

The processor 706 may comprise a central processing unit (CPU), a microprocessor, a multi-core processor, or any other type of processing system that is capable of sending control signals to the projection system 702 and to the light receiving system 704. For instance, the processor 706 may send control signals to the projection system that cause the light sources of the projection system 702 to activate or emit light that creates a projection pattern in the field of view. The processor 706 may also send control signals to the light receiving system 704 that cause the camera of the light receiving system 704 to capture one or more images of the field of view (e.g., potentially after the light sources of the projection system 702 have been activated).

Additionally, the processor 706 may receive captured images from the camera of the light receiving system 704 and may calculated the distance from the distance sensor 700 to an object in the field of view based on the appearance of the projection pattern in the captured images, as discussed above.

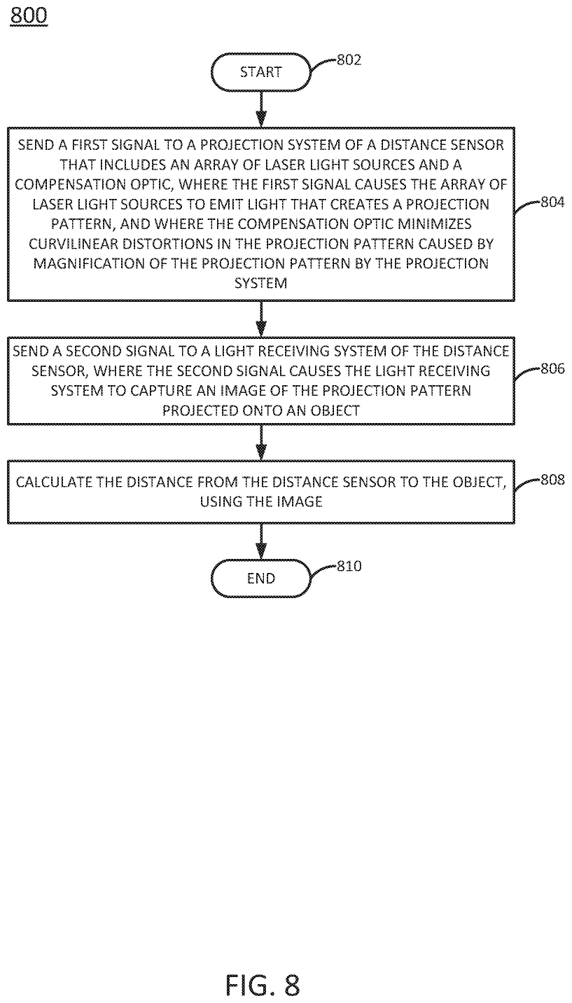

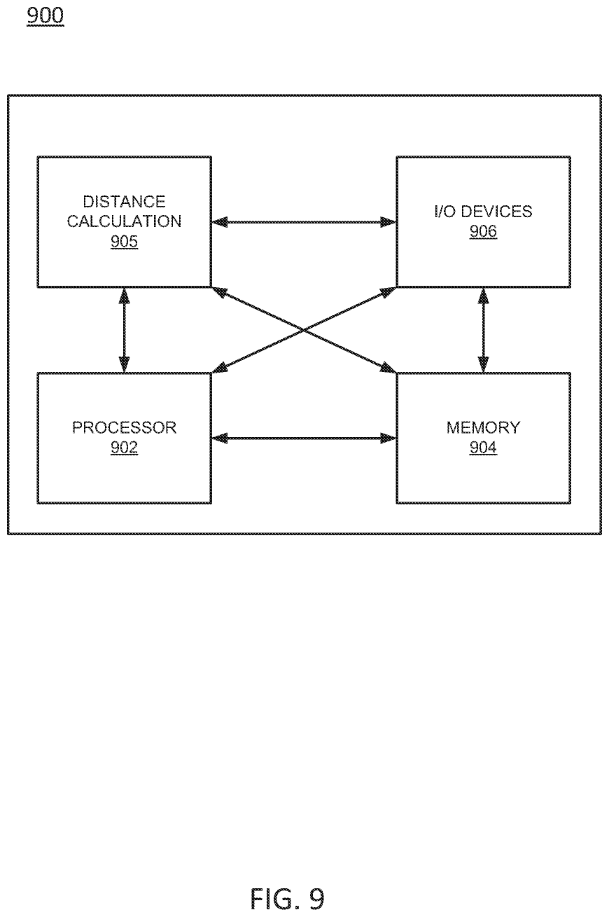

FIG. 8 is a flow diagram illustrating one example of a method 800 for distance measurement using a distance sensor with a compensation optic for minimizing distortions in the projection pattern, e.g., as illustrated in FIG. 7. The method 800 may be performed, for example, by a processor, such as the processor 706 of the distance sensor 700 or the processor 902 illustrated in FIG. 9. For the sake of example, the method 800 is described as being performed by a processing system.

The method 800 may begin in step 802. In step 804, the processing system may send a first signal to a projection system of a distance sensor that includes an array of laser light sources and a compensation optic, where the first signal causes the array of laser light sources to emit a plurality of beams of light (e.g., infrared light) that creates a projection pattern, and where the compensation optic minimizes curvilinear distortions in the projection pattern that are caused by magnification of the projection pattern by the projection system. In one example, the array of laser light sources may comprise an array of VCSEL light sources arranged in a grid pattern having a substantially regular interval (e.g., as illustrated in the inset of FIG. 1).

In one example, the compensation optic may comprise a second lens that is positioned behind the focal point of a first lens (e.g., between the first lens and the object whose distance is being measured). In this case, both the first lens and the second lens may comprise converging lenses. FIG. 3, for instance, illustrates this example.

In another example, the compensation optic may comprise an aspheric lens that is positioned between the array of laser light sources and the object whose distance is being measured. FIG. 4, for instance, illustrates this example.

In another example, the compensation optic may comprise a diffractive optical element that is positioned at the focal point of a first lens (e.g., between the first lens and the object whose distance is being measured). In this case, the first lens may be a converging lens or an aspheric lens. FIG. 5, for instance, illustrates this example.

In another example, the compensation optic may comprise a diffractive optical element that is positioned at the focal point of a first lens, and a second lens that is positioned behind the focal point (e.g., between the diffractive optical element and the object whose distance is being measured). In this case, the first lens and the second lens may both be converging lenses. FIG. 6, for instance, illustrates this example.

As discussed above, the plurality of beams of light may form a projection pattern, i.e., a pattern of light comprising a plurality of projection artifacts, on a surface that is near the array of laser light sources. The projection artifacts may be created by respective beams of light that are incident on the surface. The wavelength of the light that forms the beams (and, therefore, the projection artifacts) may be substantially invisible to the human eye, but visible to a detector of a camera (e.g., infrared light).

In step 806, the processing system may send a second signal to a light receiving system of the distance sensor (which includes a camera), where the second signal causes the light receiving system to capture an image of the projection pattern projected onto an object. The object may be an object in a field of view of the light receiving system.

In step 808, the processing system may calculate the distance from the distance sensor to the surface, using the image captured in step 806. In particular, the distance may be calculated based on the appearance of the projection pattern in the image.

The method 800 may end in step 810.

It should be noted that although not explicitly specified, some of the blocks, functions, or operations of the method 800 described above may include storing, displaying and/or outputting for a particular application. In other words, any data, records, fields, and/or intermediate results discussed in the method 800 can be stored, displayed, and/or outputted to another device depending on the particular application. Furthermore, blocks, functions, or operations in FIG. 8 that recite a determining operation, or involve a decision, do not imply that both branches of the determining operation are practiced. In other words, one of the branches of the determining operation may not be performed, depending on the results of the determining operation.

FIG. 9 depicts a high-level block diagram of an example electronic device 900 for calculating the distance from a sensor to an object. As such, the electronic device 900 may be implemented as a processor of an electronic device or system, such as a distance sensor.

As depicted in FIG. 9, the electronic device 900 comprises a hardware processor element 902, e.g., a central processing unit (CPU), a microprocessor, or a multi-core processor, a memory 904, e.g., random access memory (RAM) and/or read only memory (ROM), a module 905 for calculating the distance from a sensor to an object, and various input/output devices 906, e.g., storage devices, including but not limited to, a tape drive, a floppy drive, a hard disk drive or a compact disk drive, a receiver, a transmitter, a display, an output port, an input port, and a user input device, such as a keyboard, a keypad, a mouse, a microphone, a camera, a laser light source, an LED light source, and the like.

Although one processor element is shown, it should be noted that the electronic device 900 may employ a plurality of processor elements.

Furthermore, although one electronic device 900 is shown in the figure, if the method(s) as discussed above is implemented in a distributed or parallel manner for a particular illustrative example, i.e., the blocks of the above method(s) or the entire method(s) are implemented across multiple or parallel electronic devices, then the electronic device 900 of this figure is intended to represent each of those multiple electronic devices.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the blocks, functions and/or operations of the above disclosed method(s).

In one example, instructions and data for the present module or process 905 for calculating the distance from a sensor to an object, e.g., machine readable instructions can be loaded into memory 904 and executed by hardware processor element 902 to implement the blocks, functions or operations as discussed above in connection with the method 800. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 905 for calculating the distance from a sensor to an object of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or an electronic device such as a computer or a controller of a safety sensor system.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A distance sensor, comprising:
a projection system, the projection system comprising:
a plurality of laser light sources arranged in an array to emit a plurality of beams of light that forms a grid-shaped projection pattern when the plurality of beams of light is incident on a surface; and
a compensation optic to minimize a magnification-induced curvilinear distortion of the grid-shaped projection pattern before the plurality of beams of light is incident on the surface;
a light receiving system to capture an image of the grid-shaped projection pattern on the surface; and
a processor to calculate a distance from the distance sensor to the surface, based on an appearance of the grid-shaped projection pattern in the image.

2. The distance sensor of claim 1, wherein the plurality of laser light sources comprises a plurality of vertical cavity surface emitting lasers that emit infrared light.

3. The distance sensor of claim 1, wherein the projection system further comprises:
a first lens positioned between the plurality of laser light sources and the compensation optic, to magnify the grid-shaped projection pattern.

4. The distance sensor of claim 3, wherein the first lens is a converging lens.

5. The distance sensor of claim 4, wherein the compensation optic comprises:
a second lens positioned behind a focal point of the first lens, wherein the second lens is also a converging lens.

6. The distance sensor of claim 4, wherein the compensation optic comprises:
a diffractive optical element positioned at a focal point of the first lens.

7. The distance sensor of claim 6, wherein the compensation optic further comprises:
a second lens, wherein the diffractive optical element is positioned between the first lens and the second lens.

8. The distance sensor of claim 3, wherein the first lens is an aspheric lens.

9. The distance sensor of claim 8, wherein the compensation optic comprises:
a diffractive optical element positioned at a focal point of the first lens.

10. The distance sensor of claim 1, wherein the compensation optic comprises:
an aspheric lens.

11. A method, comprising:
sending, by a processing system of a distance sensor, a first signal to a projection system of the distance sensor that includes an array of laser light sources and a compensation optic, wherein the first signal causes the array of laser light sources to emit a plurality of beams of light that creates a grid-shaped projection pattern when the plurality of beams of light is incident on a surface, and wherein the compensation optic minimizes a magnification-induced curvilinear distortion of the grid-shaped projection pattern before the plurality of beams of light is incident on the surface;
sending, by the processing system, a second signal to a light receiving system of the distance sensor, wherein the second signal causes the light receiving system to capture an image of the grid-shaped projection pattern projected onto the surface; and
calculating, by the processing system, a distance from the distance sensor to the surface, based on appearances of the grid-shaped projection pattern in the image.

12. The method of claim 11, wherein the array of laser light sources comprises an array of vertical cavity surface emitting lasers that emit infrared light.

13. The method of claim 11, wherein the projection system further comprises:
a first lens positioned between the array of laser light sources and the compensation optic, to magnify the grid-shaped projection pattern.

14. The method of claim 13, wherein the first lens is a converging lens.

15. The method of claim 14, wherein the compensation optic comprises:
a second lens positioned behind a focal point of the first lens, wherein the second lens is also a converging lens.

16. The method of claim 14, wherein the compensation optic comprises:
a diffractive optical element positioned at a focal point of the first lens.

17. The method of claim 16, wherein the compensation optic further comprises:
a second lens, wherein the diffractive optical element is positioned between the first lens and the second lens.

18. The method of claim 13, wherein the first lens is an aspheric lens, and wherein the compensation optic comprises a diffractive optical element positioned at a focal point of the first lens.

19. The method of claim 11, wherein the compensation optic comprises:
an aspheric lens.

20. A non-transitory machine-readable storage medium encoded with instructions executable by a processor of a distance sensor, wherein, when executed, the instructions cause the processor to perform operations, the operations comprising:
sending a first signal to a projection system of the distance sensor that includes an array of laser light sources and a compensation optic, wherein the first signal causes the array of laser light sources to emit a plurality of beams of light that creates a grid-shaped projection pattern when the plurality of beams of light is incident on a surface, and wherein the compensation optic minimizes a magnification-induced curvilinear distortion of the grid-shaped projection pattern before the plurality of beams of light is incident on the surface;
sending a second signal to a light receiving system of the distance sensor, wherein the second signal causes the light receiving system to capture an image of the grid-shaped projection pattern projected onto the surface; and
calculating a distance from the distance sensor to the surface, based on appearances of the grid-shaped projection pattern in the image.
